(19) United States
(12) Patent Application Publication
(10) Pub. No.: US 2017/0210863 A1
(43) Pub. Date: Jul. 27, 2017

(54) FLAME-RETARDANT CROSSLINKED RESIN MOLDED BODY, FLAME-RETARDANT CROSSLINKABLE RESIN COMPOSITION, METHOD OF PRODUCING THESE, FLAME-RETARDANT SILANE MASTER BATCH, AND MOLDED ARTICLE

(71) Applicant: FURUKAWA ELECTRIC CO., LTD., Tokyo (JP)

(72) Inventors: Masaki NISHIGUCHI, Tokyo (JP); Arifumi MATSUMURA, Tokyo (JP)

(73) Assignee: FURUKAWA ELECTRIC CO., LTD., Tokyo (JP)

(21) Appl. No.: 15/480,940

(22) Filed: Apr. 6, 2017

Related U.S. Application Data
(63) Continuation of application No. PCT/JP2015/078682, filed on Oct. 8, 2015.

(30) Foreign Application Priority Data
Oct. 8, 2014 (JP) 2014-207604

(51) Int. Cl. C08J 3/24; C08L 25/06; C08J 3/22; C09K 21/14; C09K 21/06; C08L 23/16; C08L 23/06

(52) U.S. Cl. CPC C08J 3/24; C08L 23/16; C08L 25/06; C08L 23/06; C09K 21/14; C09K 21/06; C08J 3/22; C08L 2201/02; C08L 2205/02; C08L 2205/035; C08L 2205/03; C08L 2312/08; C08J 2323/16; C08J 2325/06; C08J 2323/06; C08J 2423/06; C08J 2423/12; C08J 2423/16; C08J 2431/04

(57) ABSTRACT

A production method, containing the step of mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst, in which the inorganic filler has an X value specified by Formula (I) satisfies 7 to 850; and a flame-retardant crosslinkable resin composition and a flame-retardant crosslinked resin molded body produced by the production method; and a flame-retardant silane master batch and a molded article.

X=ΣA/B Formula (I)
wherein, ΣA denotes a total amount of a product of a BET specific surface area (m²/g) of the inorganic filler and a blending amount of the inorganic filler, and B denotes a blending amount of the silane coupling agent.

### CROSS-REFERENCE TO RELATED APPLICATIONS

This application is a continuation of PCT/JP2015/078682 filed on Oct. 8, 2015 which claims benefit of Japanese Patent Application No. 2014-207604 filed on Oct. 8, 2014, the subject matters of which are incorporated herein by reference in their entirety.

### TECHNICAL FIELD

The present invention relates to a flame-retardant crosslinked resin molded body, a flame-retardant crosslinkable resin composition, and methods of producing them, respectively, a flame-retardant silane master batch, as well as a molded article. Specifically, the present invention relates to a flame-retardant crosslinked resin molded body excellent in appearance and mechanical characteristics while maintaining flame retardancy and heat resistance and a method of producing the same, a flame-retardant silane master batch and a flame-retardant crosslinkable resin composition, capable of forming the flame-retardant crosslinked resin molded body having excellent in such properties and a method of the flame-retardant crosslinkable resin composition, as well as molded articles such as an electric wire, a rubber grommet, a rubber hose or vibration-proof rubber each using the flame-retardant crosslinked resin molded body as an insulator or a sheath.

### BACKGROUND ART

Rubber products such as an electric wire, a rubber hose (also referred to as a rubber tube), a tire, a grommet or a vibration-proof rubber have been widely used as each member for which physical properties or characteristics such as mechanical characteristics, flexibility, elasticity, repellency, and permanent compressibility are required. As a rubber material from which these rubber products are formed, a wide range of rubber materials such as ethylene-propylene-diene rubber (EPDM), styrene-butylene rubber (SBR), nitrile-butylene rubber (NBR), and fluorine-containing rubber have been used. Moreover, a crosslinked polyethylene material has been widely used as a coating material or a member for various cables by taking advantage of heat resistance thereof.

These rubber materials and crosslinked polyethylene are produced into the rubber product as described below. More specifically, a crosslinking agent such as organic peroxide and a phenolic compound is previously blended into rubber, and the resultant blend is molded in a state in which these crosslinking agents do not sufficiently react therewith. Then, a crosslinked molded body having rubber elasticity and flexibility is obtained by heating the non-crosslinked molded body to cause crosslinking, and cooling the resultant material. For example, in a case where the electric wire is continuously produced, the rubber material or the like is molded at a low temperature of 120° C. or lower and in this state, for example, passed through a vulcanization pipe warmed by water vapor or the like to cause crosslinking, and the resultant material is further passed through a cooling pipe cooled by water or the like.

Thus, in a case where the rubber material or the crosslinked polyethylene as described above is used, upon molding these rubber materials or the like, it is required to mold the materials at a temperature at which the crosslinking agents cause no reaction, and then sufficiently heat the molded material at a temperature at which the crosslinking agents are decomposed to cause reaction, while keeping the molded state, to progress crosslinking, and to cool the resultant material. Therefore, a long period of time is required for production thereof.

Moreover, usually, the rubber material or the like should be molded at the temperature at which the crosslinking agents cause no reaction, which has posed a problem of difficulty in molding the material by a specific method such as injection molding.

As a method of solving these problems, proposals have been made on a method of dynamically crosslinking, by using organic peroxide through metal hydrate subjected to silane surface treatment, a vinyl aromatic thermoplastic elastomer composition prepared by using a thermoplastic elastomer, or a block copolymer described in Patent Literatures 1 to 3, or the like as a base resin, and adding a softener for non-aromatic rubber as a softener. However, while these thermoplastic elastomers have flexibility, these elastomers are melted at a high temperature, and therefore are unable to be used as the rubber product.

Incidentally, specific examples of a method of crosslinking a polyolefin-based resin such as polyethylene include an electron beam crosslinking method using an electron beam, and a silane crosslinking method.

However, in the electron beam crosslinking method, not only cost for facilities is significantly high, but also a thickness of the molded body which can be produced is restricted, and therefore such a method is unable to be applied for the various rubber products. On the other hand, the silane crosslinking method is a method of obtaining a crosslinked molded body, by a grafting reaction of a silane coupling agent onto a polymer in the presence of organic peroxides, to obtain a silane graft polymer, and then contacting the silane graft polymer with water in the presence of a silanol condensation catalyst. This silane crosslinking method requires no special facilities in many cases. Accordingly, among the above-described crosslinking methods, the silane crosslinking method has been particularly applied in a wide range of fields.

Usually, in a case where a filler is mixed with a resin, a Banbury mixer, a kneader mixer or a twin screw extruder is used. However, if the kneader or the Banbury mixer is used in a case where the resin containing the filler is crosslinked by the silane crosslinking method, a silane coupling agent is volatized before a silane grafting reaction because of high volatility. Therefore, it becomes difficult to prepare a flame-retardant silane master batch containing a silane graft polymer and the filler. Moreover, also in a case where the twin screw extruder is used, problems of difficulty in resin pressure control and easily causing foaming remain.

Therefore, in the case of preparing a flame-retardant silane master batch with a Banbury mixer or a kneader, consideration might be given to a method which includes adding a silane coupling agent to a flame-retardant master batch prepared by melt-mixing polyolefin and a flame retardant, and then subjecting the resultant to the silane coupling agent is reacted onto polyolefin so as to form a graft in a single-screw extruder. However, this method may cause poor appearance. Moreover, if an antidegradant is incorporated into the flame-retardant master batch, inhibition of the silane grafting reaction is caused, and desired heat resistance is unable to be obtained in several cases.

As another method, Patent Literature 4 describes a method in which an inorganic filler surface-treated with a silane coupling agent, a silane coupling agent, an organic peroxide, and a crosslinking catalyst are melt-kneaded with olefin-based resin using a kneader, and then the blend is molded using a single-screw extruder. However, according to the method described in Patent Literature 4, the olefin-based resin resins are crosslinked with each other during melt-kneading in a kneader, and the crosslink causes poor appearance. Further, a greater part of silane coupling agent other than the silane coupling agents with which the inorganic filler is surface-treated, is volatilized or the silane coupling agents are condensed with each other. For this reason, the desired heat resistance cannot be obtained and, in addition, poor appearance may be caused by condensation of the silane coupling agents.

### CITATION LIST

### Patent Literatures

Patent Literature 1: JP-A-2000-143935 (“JP-A” means unexamined published Japanese patent application)

Patent Literature 2: JP-A-2000-315424

Patent Literature 3: JP-A-2001-240719

Patent Literature 4: JP-A-2001-101928

### SUMMARY OF INVENTION

### Technical Problem

The present invention is made to solve the above-described problems, and contemplated for providing a flame-retardant crosslinked resin molded body which is produced by suppressing volatilization of a silane coupling agent, and while maintaining flame retardancy and heat resistance, has also excellent appearance and mechanical characteristics, and a method of producing the same.

Further, the present invention is contemplated for providing a flame-retardant silane master batch and a flame-retardant crosslinkable resin composition, which are capable of producing the flame-retardant crosslinked resin molded body, and providing a method of producing the flame-retardant crosslinkable resin composition.

Further, the present invention is contemplated for providing a molded article containing the flame-retardant crosslinked resin molded body.

### Solution to Problem

The present inventors found that, upon allowing a graft reaction of a silane coupling agent with a polyolefin-based resin in the presence of an inorganic filler, if the silane coupling agent and the inorganic filler containing a specific amount of metal hydrate are simultaneously used under conditions in which an X value specified by Formula (I) satisfies a specific value, volatilization of the silane coupling agent can be prevented, and a flame-retardant crosslinked resin molded body having maintained flame retardancy and heat resistance and also excellent appearance and mechanical characteristics can be obtained. The present inventors further continued to conduct research based on these findings, and completed the present invention.

The above-described problems of the present invention can be solved by the following means.

<1> A method of producing a flame-retardant crosslinked resin molded body, having the following steps (1), (2) and (3):

a step (1): obtaining a mixture by mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst;

step (2): obtaining a molded body by molding the mixture obtained in the step (1); and

step (3): obtaining a flame-retardant crosslinked resin molded body by bringing the molded body obtained in the step (2) into contact with water,

wherein the step (1) has the following steps (a) to (d):

step (a): mixing the organic peroxide, the inorganic filler in which an X value specified by Formula (I) satisfies 7 to 850, and the silane coupling agent;

X=ΣA/B Formula (I)

wherein, ΣA denotes a total amount of a product of a BET specific surface area (m²/g) of the inorganic filler and a blending amount of the inorganic filler, and B denotes a blending amount of the silane coupling agent;

step (b): melt-mixing the mixture obtained in the step (a) with a whole or part of the polyolefin-based resin at a temperature equal to or higher than a decomposition temperature of the organic peroxide;

step (c): mixing the silanol condensation catalyst with, as a carrier resin, a resin different from the polyolefin-based resin or a remaining portion of the polyolefin-based resin; and

step (d): mixing a melted mixture obtained in the step (b) with a mixture obtained in the step (c).

<2> The method of producing a flame-retardant crosslinked resin molded body described in the above item <1>, wherein the silane coupling agent is vinyltrimethoxysilane or vinyltriethoxysilane.
<3> The method of producing a flame-retardant crosslinked resin molded body described in the above item <1> or <2>, wherein the inorganic filler contains at least one kind selected from the group consisting of silica, calcium carbonate, magnesium carbonate, clay, kaoline, talc, zinc borate, zinc hydroxystannate, and antimony trioxide.
<4> A method of producing a flame-retardant crosslinkable resin composition, having the step of:

mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst;

wherein the step has the following steps (a) to (d):

step (a): mixing the organic peroxide, the inorganic filler in which an X value specified by Formula (I) satisfies 7 to 850, and the silane coupling agent;

X=ΣA/B Formula (I)

wherein, ΣA denotes a total amount of a product of a BET specific surface area (m²/g) of the inorganic filler and a blending amount of the inorganic filler, and B denotes a blending amount of the silane coupling agent;

step (b): melt-mixing the mixture obtained in the step (a) with a whole or part of the polyolefin-based resin at a temperature equal to or higher than a decomposition temperature of the organic peroxide;

step (c): mixing the silanol condensation catalyst with, as a carrier resin, a resin different from the polyolefin-based resin or a remaining portion of the polyolefin-based resin; and

step (d): mixing a melted mixture obtained in the step (b) with a mixture obtained in the step (c).

<5> A flame-retardant crosslinkable resin produced by the method of producing a flame-retardant crosslinkable resin composition described in the above item <4>.
<6> A flame-retardant crosslinked resin molded body produced by the method of producing a flame-retardant crosslinked resin molded body described in any one of the above items <1> to <3>.
<7> A molded article, containing the flame-retardant crosslinked resin molded body described in the above item <6>.
<8> A flame-retardant silane master batch used for producing a flame-retardant crosslinkable resin composition prepared by mixing 0.02 to 0.6 parts by mass of an organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst,

wherein the flame-retardant silane master batch is prepared through the following steps (a) and (b):

step (a): mixing the organic peroxide, the inorganic filler in which an X value specified by Formula (I) satisfies 7 to 850, and the silane coupling agent;

X=ΣA/B Formula (I)

wherein, ΣA denotes a total amount of a product of a BET specific surface area (m²/g) of the inorganic filler and a blending amount of the inorganic filler, and B denotes a blending amount of the silane coupling agent;

step (b): melt-mixing the mixture obtained in the step (a) with a whole or part of the polyolefin-based resin at a temperature equal to or higher than a decomposition temperature of the organic peroxide.

Note that, in this specification, numerical expressions in a style of “ . . . to . . . ” will be used to indicate a range including the lower and upper limits represented by the numerals given before and after “to”, respectively.

### Advantageous Effects of Invention

According to the present invention, an inorganic filler and a silane coupling agent are mixed before and/or during kneading with the polyolefin-based resin and thus, volatilization of the silane coupling agent during kneading can be suppressed, and the flame-retardant crosslinked resin molded body can be easily and efficiently produced. Furthermore, the problems of the conventional silane crosslinking method can be overcome by simultaneously using the specific inorganic filler with the silane coupling agent, and a flame-retardant crosslinked resin molded body excellent in flame retardancy, heat resistance, appearance, and mechanical characteristics can be produced.

Accordingly, according to the present invention, a flame-retardant crosslinked resin molded body which has also excellent appearance and mechanical characteristics while maintaining flame retardancy and heat resistance, and which can be produced with the volatilization of the silane coupling agent being suppressed and a method of producing the flame-retardant crosslinked resin molded body is provided.

Further, according to the present invention, a flame-retardant silane master batch and a flame-retardant crosslinkable resin composition, capable of forming the flame-retardant crosslinked resin molded body having excellent in such properties, as well as a method of the flame-retardant crosslinkable resin composition can be provided.

Further, according to the present invention, a molded article containing the flame-retardant crosslinked resin molded body excellent in the above properties can be provided.

Other and further features and advantages of the invention will appear more fully from the following description.

### MODE FOR CARRYING OUT THE INVENTION

The preferable embodiment of the present invention is described in detail below.

In both of the “method of producing a flame-retardant crosslinked resin molded body” of the present invention and the “method of producing a flame-retardant crosslinkable resin composition” of the present invention, the step (1) below is conducted. Further, “silane master batch” of the present invention is prepared through the steps (a) and (b) below.

Accordingly, the “method of producing a flame-retardant crosslinked resin molded body” of the present invention and the “method of producing a flame-retardant crosslinkable resin composition” of the present invention (in the description of parts common to both, the methods may be collectively referred to as a production method of the present invention in some cases) are collectively described below. Moreover, a part common with the production method of the present invention in the method of producing the “silane master batch” of the present invention will be simultaneously described.

Step (1): obtaining a mixture by mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst.

Step (2): obtaining a molded body by molding the mixture obtained in the step (1).

Step (3): obtaining a flame-retardant crosslinked resin molded body by bringing the molded body obtained in the step (2) into contact with water.

The step (1) has the following step (a), step (b), step (c), and step (d).

Step (a): mixing the organic peroxide, the inorganic filler in which an X value specified by Formula (I) satisfies 7 to 850, and the silane coupling agent;

X=ΣA/B Formula (I)

wherein, ΣA denotes a total amount of a product of a BET specific surface area (m²/g) of the inorganic filler and a blending amount of the inorganic filler, and B denotes a blending amount of the silane coupling agent.

Step (b): melt-mixing the mixture obtained in the step (a) with a whole or part of the polyolefin-based resin at a temperature equal to or higher than a decomposition temperature of the organic peroxide,

Step (c): mixing the silanol condensation catalyst with, as a carrier resin, a resin different from the polyolefin-based resin or a remaining portion of the polyolefin-based resin.

Step (d): mixing a melted mixture obtained in the step (b) with a mixture obtained in the step (c).

The components used in the present invention are described.

### <Polyolefin-Based Resin>

The polyolefin-based resin used in the present invention is not particularly limited, and publicly known resin which has been so far used in the flame-retardant resin composition can be used. Specific examples thereof include each resin of polyethylene, polypropylene, an ethylene-α-olefin copolymer, and a copolymer having an acid copolymerization component or an acid ester copolymerization component; and rubber or elastomer of these polymers.

Among them, in view of high acceptability of various inorganic fillers including the metal hydrate and the like, having an effect of maintaining mechanical strength (tensile strength) even if a large amount of the inorganic filler is blended, and suppressing reduction of withstand voltage, particularly withstand voltage characteristics at a high temperature while ensuring flame retardancy, polyethylene, an ethylene-α-olefin copolymer, or a copolymer having an acid copolymerization component or an acid ester copolymerization component is preferable.

The polyolefin-based resin may be used in one kind thereof or in combination of the two or more kinds thereof.

In a case where the polyolefin-based resin contains a plurality of components, a content of each component is appropriately adjusted in such a manner that a total of each component comes to 100 mass %, and preferably selected from the following range.

The polyethylene is not particularly limited, and examples thereof include a homopolymer of ethylene, high-density polyethylene (HDPE), low-density polyethylene (LDPE), ultra-high molecular weight polyethylene (UHMW-PE), linear low-density polyethylene (LLDPE), and very-low-density polyethylene (VLDPE). Among them, linear low-density polyethylene or low-density polyethylene is preferable.

A blending amount of polyethylene is preferably 0 to 95 mass %, and further preferably 0 to 60 mass % in the polyolefin-based resin.

The polypropylene includes a propylene homopolymer, and also, as a copolymer, an ethylene-propylene copolymer such as random polypropylene, and block polypropylene.

A blending amount of polypropylene is preferably 0 to 50 mass %, and further preferably 0 to 30 mass % in the polyolefin-based resin.

The ethylene-α-olefin copolymer is not particularly limited as long as a copolymer other than polyethylene and polypropylene is applied, and specific examples thereof include preferably a copolymer of ethylene and α-olefin having 3 to 12 carbon atoms, and further preferably a copolymer of ethylene and α-olefin having 4 to 12 carbon atoms. Specific examples of α-olefin is not particularly limited and include propylene, 1-butene, 1-hexene, 4-methyl-1-pentene, 1-octene, 1-decene, 1-dodecene, and the like. The ethylene-α-olefin copolymer is not particularly limited and specific examples thereof include an ethylene-propylene copolymer, an ethylene-butylene copolymer, and an ethylene-α-olefin copolymer that is synthesized in the presence of a single-site catalyst.

In the polyolefin-based resin, a blending amount of the ethylene-α-olefin copolymer is preferably from 0 to 95 mass %, and further preferably from 0 to 80 mass %.

The copolymer having the acid copolymerization component or the acid ester copolymerization component is not particularly limited and the specific examples thereof include ethylene-vinyl acetate copolymer, ethylene-(meth)acrylic acid copolymers, ethylene-alkyl (meth)acrylate copolymers or the like. Among them, ethylene-vinyl acetate copolymers, ethylene-methyl acrylate copolymers, ethylene-ethyl acrylate copolymers, and ethylene-butyl acrylate copolymers are preferable; and ethylene-vinyl acetate copolymers are more preferable from the standpoint of the acceptability to the inorganic filler and flame retardancy.

A blending amount of the copolymer having the acid copolymerization component or the acid ester copolymerization component is preferably 0 to 80 mass %, and further preferably 0 to 50 mass % in the polyolefin-based resin.

The elastomer to be used in the present invention is not particularly limited, and specific examples thereof include a styrene-based elastomer such as a styrene-butylene-styrene block copolymer (SBS), a styrene-isoprene-styrene block copolymer (SIS), a styrene-ethylene-propylene-styrene block copolymer (SEPS), a styrene-ethylene-ethylene-propylene-styrene block copolymer (SEEPS), and styrene-ethylene-butylene-styrene block copolymer (SEBS).

A blending amount of elastomer is preferably 0 to 95 mass %, and further preferably 0 to 80 mass % in the polyolefin-based resin.

The rubber to be used in the present invention is not particularly limited, but ethylene rubber is preferable. The ethylene rubber is not particularly limited, as long as the ethylene rubber is rubber (including elastomer) of the copolymer obtained by copolymerizing a compound having an ethylenically unsaturated bond. Specific examples of the ethylene rubber preferably include a rubber of a copolymer of ethylene and α-olefin, and a rubber of a terpolymer of ethylene, α-olefin and diene. As α-olefin, α-olefin having 3 to 12 carbon atoms is preferable. Specific examples of the rubber of the copolymer of ethylene and α-olefin include ethylene-propylene rubber (EPR), ethylene-butene rubber (EBR), and ethylene-octene rubber. Specific examples of the rubber of the terpolymer of ethylene, α-olefin, and diene include ethylene-propylene-diene rubber and ethylene-butene-diene rubber.

A blending amount of ethylene rubber is preferably 0 to 90 mass %, and further preferably 0 to 60 mass % in the polyolefin-based resin.

In the present invention, the polyolefin-based resin may contain paraffin oil or naphthene oil. In particular, the rubber (ethylene rubber) or the styrene-based elastomer as described above and paraffin oil or naphthene oil are preferably used in combination thereof. As the oil, the paraffin oil is preferable in view of mechanical strength.

A blending amount of oil is preferably 0 to 60 mass %, and further preferably 0 to 40 mass % in the polyolefin-based resin.

In the present invention, the oil is to be contained in the polyolefin-based resin.

The resin may contain, in addition to the above-described components, an additive to be described later or a resin component other than the above-described resin components.

### <Organic Peroxide>

The organic peroxide plays a role of generating a radical at least by thermal decomposition, to cause a grafting reaction of the silane coupling agent onto the polyolefin resin component, as a catalyst.

The organic peroxide to be used in the present invention is not particularly limited, as long as the organic peroxide is one that generates a radical.

For example, as the organic peroxide, the compound represented by the formula R¹—OO—R², R¹—OO—C(═O)R³, or R⁴C(═O)—OO(C═O)R⁵ is preferable. Herein, R¹, R², R³, R⁴, and R⁵ each independently represent an alkyl group, an aryl group, or an acyl group. Among them, in the present invention, it is preferable that all of R¹, R², R³, R⁴, and R⁵ be an alkyl group, or any one of them be an alkyl group, and the rest be an acyl group.

Examples of such organic peroxide may include dicumyl peroxide (DCP), di-tert-butyl peroxide, 2,5-dimethyl-2,5-di-(tert-butyl peroxy)hexane, 2,5-dimethyl-2,5-di(tert-butyl peroxy)hexine-3, 1,3-bis(tert-butyl peroxyisopropyl)benzene, 1,1-bis(tert-butyl peroxy)-3,3,5-trimethylcyclohexane, n-butyl-4,4-bis(tert-butyl peroxy)valerate, benzoyl peroxide, p-chlorobenzoyl peroxide, 2,4-dichlorobenzoyl peroxide, tert-butyl peroxybenzoate, tert-butyl peroxyisopropyl carbonate, diacetyl peroxide, lauroyl peroxide, tert-butylcumyl peroxide and the like. Among them, 2,5-dimethyl-2,5-di-(tert-butyl peroxy)hexane, or 2,5-dimethyl-2,5-di-(tert-butyl peroxy)hexine-3 is preferable, from the standpoint of odor, coloration, and scorch stability.

The decomposition temperature of the organic peroxide is preferably 120 to 190° C., and more preferably 125 to 180° C.

In the present invention, the decomposition temperature of the organic peroxide means the temperature, at which, when an organic peroxide having a single composition is heated, the organic peroxide itself causes a decomposition reaction and decomposes into two or more kinds of compounds at a certain temperature or temperature range. In specific, the decomposition temperature is a temperature at which heat absorption or exothermic reaction starts, when the organic peroxide is heated at room temperature in a rising rate of 5° C./min under a nitrogen gas atmosphere, by a thermal analysis such as a DSC method.

### <Inorganic Filler>

The inorganic filler used in the present invention contains at least one kind of metal hydrate. Accordingly, the inorganic filler includes an aspect in which one kind or two or more kinds of metal hydrates are used alone, and an aspect in which one kind or two or more kinds of metal hydrates and one kind or two or more kinds of inorganic fillers other than the metal hydrate are simultaneously used.

### (Metal Hydrate)

Specific examples of the metal hydrate used in the present invention include metal hydroxide such as aluminum hydroxide, magnesium hydroxide, calcium hydroxide, barium hydroxide or aluminum oxide monohydrate. Among them, magnesium hydroxide or aluminum hydroxide is preferable.

The BET specific surface area Yi (m²/g) of the metal hydroxide is not particularly limited as long as an X value specified by Formula (I) to be described later satisfies the above-described range. In view of exhibiting an expected effect without reducing an amount of the silane coupling agent to be bonded onto a surface of the metal hydroxide, and further in view of a capability of reducing the blending amount of the metal hydroxide, the BET specific surface area of the metal hydroxide is preferably 2 to 20 m²/g.

The BET specific surface area Yi (m²/g) of the metal hydroxide is expressed in terms of a value measured by using a nitrogen gas as an adsorbate in accordance with a “carrier-gas method” of JIS Z 8830:2013. For example, the value measured by using a specific surface area and pore distribution measuring device “FlowSorb” (manufactured by Shimadzu Corporation) is applied.

An average particle diameter of the metal hydrate is not particularly limited, but is preferably 0.3 to 2.5 μm.

As the metal hydrate, a material without treatment, a material previously treated with fatty acid such as stearic acid and oleic acid, a material treated with the silane coupling agent, a material treated with a titanate catalyst, a material treated with phosphate, or the like can be used.

Specific examples of the magnesium hydroxide include a material without surface treatment (as a commercial product, KISUMA 5 (tradename, manufactured by Kyowa Chemical Industry Co., Ltd.) and the like), a material surface-treated with fatty acid such as stearic acid, oleic acid and the like (KISUMA 5A, KUSUMA 5B (tradenames, manufactured by Kyowa Chemical Industry Co., Ltd.) and the like), and a material prepared by further applying surface treatment to a material surface-treated with phosphate (KISUMA 5J (tradename, manufactured by Kyowa Chemical Industry Co., Ltd.) and the like) with a silanol compound having a vinyl group or an epoxy group at an end described below. Moreover, specific examples thereof include a commercial product of magnesium hydroxide already surface-treated with a silanol compound having a vinyl group or an epoxy group at an end (KISUMA 5L, KISUMA 5P (tradenames for all, manufactured by Kyowa Chemical Industry Co., Ltd.) and the like).

In addition to the above-described material, specific examples thereof also include metal hydrate prepared by applying surface treatment, by using a silanol compound having a functional group such as a vinyl group and an epoxy group at an end, to magnesium hydroxide or aluminum hydroxide a surface of which is partially pretreated with fatty acid, phosphate or the like.

One kind of the metal hydrate may be used alone, two or more kinds thereof may be simultaneously used.

(Inorganic Filler Other than the Metal Hydrate)

The inorganic filler other than the metal hydrate is not particularly limited, and specific examples include calcium carbonate, magnesium carbonate, calcium silicate, magnesium silicate, calcium oxide, magnesium oxide, aluminum oxide, aluminum nitride, aluminum borate whiskers, hydrated aluminum silicate, hydrated magnesium silicate, basic magnesium carbonate, boron nitride, silica (crystalline silica, amorphous silica, or the like), carbon, clay, zinc oxide, tin oxide, titanium oxide, molybdenum oxide, antimony trioxide, a silicone compound, quartz, talc, zinc borate, kaoline, zinc hydroxystannate, zinc stannate, a bromine-based flame retardant, and a chlorine-based flame retardant.

As the inorganic filler other than the metal hydrate, a material without treatment, a material previously treated with fatty acid such as stearic acid and oleic acid, a material treated with the silane coupling agent, a material treated with a titanate catalyst, a material treated with phosphate, or the like can be used.

Among these inorganic fillers, at least one kind selected from the group consisting of silica, calcium carbonate, magnesium carbonate, clay, kaoline, talc, zinc borate, zinc hydroxystannate, and antimony trioxide is preferable.

The BET specific surface area Yi (m²/g) of the inorganic filler other than the metal hydrate is not particularly limited, and is preferably in the range same with the range of the metal hydrate.

When the inorganic filler other than the metal hydrate is powder, an average particle diameter thereof is preferably 0.1 to 20 μm, further preferably 0.5 to 5 μm, and still further preferably 0.6 to 2.5 μm. If the average particle diameter of the inorganic filler is within the above-described range, the frame-resistant crosslinked resin molded body can be provided with the flame retardancy and the heat resistance, and a reinforcing effect is improved. The average particle diameter refers to an average value determined from particle diameters of 100 particles of the inorganic filler as measured by TEM, SEM or the like.

The inorganic filler may be used singly, or in combination of two or more kinds thereof.

### <Silane Coupling Agent>

The silane coupling agent (also referred to as a “hydrolyzable silanol compound”) used in the present invention is not particularly limited, and a silane coupling agent conventionally used for a flame-retardant crosslinkable resin composition may be used. As such a silane coupling agent, for example, a compound represented by the following Formula (1) is preferable.

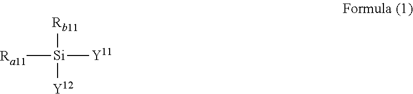

In formula (1), Rₐ₁₁ represents a group having an ethylenically unsaturated group, R_{b11} represents an aliphatic hydrocarbon group, a hydrogen atom, or Y¹³. Y¹¹, Y¹², and Y¹³ each represent a hydrolyzable organic group. Y¹¹, Y¹², and Y¹³ may be the same or different from each other.

In formula (1), Rₐ₁₁ may include a vinyl group, a (meth)acryloyl oxyalkylene group, a p-styryl group, or the like, and a vinyl group is preferable.

R_{b11} represents an aliphatic hydrocarbon group, a hydrogen atom, or Y¹³ to be described below, and Y¹³ is preferable. Example of the aliphatic hydrocarbon group may include a monovalent aliphatic hydrocarbon group having 1 to 8 carbon atoms other than an aliphatic unsaturated hydrocarbon group.

Y¹¹, Y¹², and Y¹³ each independently represent a hydrolyzable organic group, and examples thereof may include an alkoxy group, an aryloxy group, and an acyloxy group, and an alkoxy group is preferable. Specific examples of the hydrolyzable organic group may include methoxy, ethoxy, butoxy, and acyloxy. Among them, from the standpoint of the reactivity, methoxy or ethoxy is preferable.

As the silane coupling agent, a silane coupling agent that has high hydrolysis rate is preferable, and a silane coupling agent, in which R_{b11} is Y¹³ and also Y¹¹, Y¹², and Y¹³ are the same each other, is more preferable. Specific examples thereof include organosilanes such as vinyltrimethoxysilane, vinyltriethoxysilane, vinyltributoxysilane, vinyldimethoxyethoxysilane, vinyldimethoxybutoxysilane, vinyldiethoxybutoxysilane, allyltrimethoxysilane, allyltriethoxysilane, and vinyltriacetoxysilane, and silane coupling agents having an ethylenically unsaturated bond such as methacryloxypropyltrimethoxysilane, methacryloxypropyltriethoxysilane, and methacryloxypropylmethyldimethoxysilane. The silane coupling agent may be used singly or two or more kinds thereof. Among these crosslinking silane coupling agents, a silane coupling agent having a vinyl group and an alkoxy group on an end thereof is more preferable, and vinyltrimethoxysilane and vinyltriethoxysilane are still more preferable.

The silane coupling agent may be used as it is, or may be diluted with a solvent and used.

### <Silanol Condensation Catalyst>

The silanol condensation catalyst has an action of binding the silane coupling agents which have been grafted onto the polyolefin-based resin to each other, by a condensation reaction in the presence of water. Based on the action of the silanol condensation catalyst, the resin components are crosslinked between themselves through silane coupling agent. As a result, the flame-retardant crosslinked resin molded body having excellent heat resistance can be obtained.

The silanol condensation catalyst is not particularly limited and examples thereof include an organic tin compound, a metal soap, a platinum compound, and the like. Usual examples of the silanol condensation catalyst may include dibutyltin dilaurate, dioctyltin dilaurate, dibutyltin dioctylate, dibutyltin diacetate, zinc stearate, lead stearate, barium stearate, calcium stearate, sodium stearate, lead naphthenate, lead sulfate, zinc sulfate, an organic platinum compound, and the like.

### <Carrier Resin>

The carrier resin to be used in the present invention is not particularly limited, and a resin similar to the above-described polyolefin-based resin can be used. The carrier resin is preferably polyethylene in view of good affinity with the silanol condensation catalyst to produce a product having excellent flame retardancy. The carrier resin may contain a resin component such as ethylene rubber and styrene based elastomer, and/or oil.

As the carrier resin, in a case where part of the polyolefin-based resin is used in the step (b), a remaining portion of the polyolefin-based resin can be used.

In the present invention, a term “part of the polyolefin-based resin” means part of the resin to be used in the step (1) of the polyolefin-based resin. This part includes part of the polyolefin-based resin itself (having the composition same with the composition of the polyolefin-based resin), part of resin component which constitutes the polyolefin-based resin (for example, less than a total amount of a specific resin component), and a resin component of part which constitutes the polyolefin-based resin (for example, a total amount of a specific resin component of a plurality of resin components).

In addition, “remainder of the polyolefin-based resin” means a remaining polyolefin-based resin excluding the part to be used in the step (b) in the polyolefin-based resin. This remainder includes a remainder of the polyolefin-based resin itself (i.e. it has a composition same as that of the polyolefin-based resin), a remainder of the resin components that constitute the polyolefin-based resin, and a remaining resin component that constitutes the polyolefin-based resin.

### <Additive>

To the flame-retardant crosslinked resin molded body and the flame-retardant crosslinkable resin composition, various additives which are usually used for electric wires, electric cables, electric cords, may be properly used in the range that does not adversely affect the effects exhibited by the present invention. Examples of these additives include a crosslinking assistant, an antioxidant, a lubricant, a metal inactivator, a flame retardant (a flame retardant aid), and other resins.

The crosslinking assistant refers to compound that forms a partial crosslinking structure with the resin component, in the presence of the organic peroxide. Examples thereof may include polyfunctional compounds.

Examples of the antioxidant may include an amine-based antioxidant such as 4,4′-dioctyl-diphenylamine, N,N′-diphenyl-p-phenylenediamine, 2,2,4-trimethyl-1,2-dihydroquinoline polymer; a phenol-based antioxidant such as pentaerythritol-tetrakis(3-(3,5-di-tert-butyl-4-hydroxyphenyl)propionate), octadecyl-3-(3,5-di-tert-butyl-4-hydroxyphenyl)propionate, 1,3,5-trimethyl-2,4,6-tris(3,5-di-tert-butyl-4-hydroxybenzyl)benzene; and a sulfur-based antioxidant such as bis(2-methyl-4-(3-n-alkylthiopropionyloxy)-5-tert-butylphenyl)sulfide, 2-mercaptobenzimidazole and zinc salts thereof, and pentaerythritol-tetrakis(3-lauryl-thiopropionate). An antioxidant is preferably included in a content of 0.1 to 15.0 parts by mass, and more preferably included in a content of 0.1 to 10 parts by mass, with respect to 100 parts by mass of the resin.

Examples of the metal inactivator may include 1,2-bis(3-(3,5-di-tert-butyl-4-hydroxyphenyl)propionyl)hydrazine, 3-(N-salicyloyl)amino-1,2,4-triazole, and 2,2′-oxamidebis(ethyl-3-(3,5-di-tert-butyl-4-hydroxyphenyl)propionate).

Examples of the lubricant may include hydrocarbon-based, siloxane-based, fatty-acid-based, fatty-acid-amide-based, ester-based, alcohol-based, or metal-soap-based lubricants.

An acid anhydride modified material and a modified material thereof (acid-modified resin) such as maleic anhydride-modified polyethylene can be used.

When the acid anhydride modified material or a modified material thereof is used, a blending amount thereof is preferably 0.1 to 30 parts by mass, with respect to 100 parts by mass of the polyolefin-based resin (A).

Next, the production method of the present invention is specifically described.

In the production method of the present invention, in the step (1), the organic peroxide of from 0.02 to 0.6 parts by mass, the inorganic filler containing at least 20 to 350 parts by mass of metal hydrate, and 2 to 15.0 parts by mass of a silane coupling agent, based on 100 parts by mass of a polyolefin-based resin, and a silanol condensation catalyst, are mixed to prepare a mixture. In this manner, the flame-retardant crosslinkable resin composition is prepared as a mixture.

In the step (1), the blending amount of the polyolefin-based resin is not particularly limited, but is preferably an amount to be preferably 50 mass % or more, and further preferably 70 mass % or more in a content thereof in the flame-retardant crosslinkable resin composition obtained in the step (1).

In the step (1), the blending amount of the organic peroxide is 0.02 to 0.6 parts by mass, more preferably 0.04 to 0.4 parts by mass, and further preferably 0.07 to 0.2 parts by mass, with respect to 100 parts by mass of the polyolefin-based resin. Neither a crosslinking reaction between the resin components, being a side reaction, progresses nor aggregated substances are generated by adjusting the organic peroxide within this range, and a silane graftmer having excellent extrudability can be prepared.

In the present invention, the blending amount of the metal hydrate contained in the inorganic filler is 20 to 350 parts by mass based on 100 parts by mass of the polyolefin-based resin. If the blending amount of the metal hydrate is less than 20 parts by mass, the flame retardancy is not obtained in several cases. Moreover, the crosslinking reaction does not progress well, and the heat resistance is reduced in several cases. On the other hand, if the blending amount is over 350 parts by mass, the strength is significantly reduced in several cases, and the heat resistance is reduced in several cases.

The blending amount of the metal hydrate is preferably 30 to 320 parts by mass, further preferably 40 to 300 parts by mass, and particularly preferably 50 to 280 parts by mass, in view of the above-described characteristics.

In the present invention, when the inorganic filler other than the metal hydrate is used, the blending amount of this inorganic filler is not particularly limited as long as the blending amount is within the range in which the X value specified by Formula (I) is satisfied. For example, the blending amount thereof is 10 to 300 parts by mass, and preferably 30 to 250 parts by mass, based on 100 parts by mass of the polyolefin-based resin (A).

If the blending amount of the inorganic filler other than the metal hydrate is within the above-described range, the flame-retardant crosslinkable resin composition or the flame-retardant crosslinked resin molded body can be provided with the flame retardancy and the mechanical characteristics. Moreover, the flame-retardant crosslinkable resin composition and the flame-retardant crosslinked resin molded body can be easily produced and can be molded into a desired shape.

In the present invention, the blending amount of a whole of the inorganic filler is the total amount of the blending amount of the metal hydrate and the blending amount of the inorganic filler other than the metal hydrate, and preferably 30 to 650 parts by mass, for example.

A blending amount of the silane coupling agent is 2 to 15.0 parts by mass, with respect to 100 parts by mass of the polyolefin-based resin. In a case where the blending amount of the silane coupling agent is less than 2 parts by mass, the crosslinking reaction does not sufficiently progress, and the flame-retardant crosslinkable resin composition or the flame-retardant crosslinked resin molded body may be unable to be provided with desired heat resistance or mechanical characteristics in several cases. On the other hand, in a case where the blending amount is over 15.0 parts by mass, the melt and kneading may become hard in several cases, and molding into a desired shape may be unable to be achieved upon extrusion molding in several cases. A blending amount of the silane coupling agent is preferably more than 4 parts by mass and 15 parts by mass or less, more preferably more than 4 parts by mass and 12 parts by mass or less.

In the present invention, the BET specific surface area and the blending amount of the inorganic filler and the blending amount of the silane coupling agent are selected in the above-described range in such a manner that the X value specified by Formula (I) falls within the range of 7 to 850. More specifically, the inorganic filler and the silane coupling agent are used in a combination in which the X value described below falls within the range of 7 to 850.

X=ΣA/13 Formula (I)

wherein, ΣA denotes a total amount of a product of a BET specific surface area Yi (m²/g) of an inorganic filler and a blending amount Zi of the inorganic filler. Accordingly, in a case where a plurality of inorganic fillers containing the metal hydrate are used, the total amount of the product of the BET specific surface area Yi and the blending amount Zi for each inorganic filler is taken as ΣA. B denotes a blending amount of the silane coupling agent.

The blending amount Zi of the inorganic filler and the blending amount B of the silane coupling agent each are expressed in terms of a proportion (part by mass) based on 100 parts by mass of the polyolefin-based resin in the step (1).

In the present invention, the X value specified by Formula (I) specifies a relationship between the whole inorganic filler and the silane coupling agent used in the step (a). More specifically, ΣA in Formula (I) denotes the total amount of the product of the BET specific surface area Yi and the blending amount Zi for each inorganic filler. In the step (a), the silane coupling agent is bonded with or adsorbed onto each inorganic filler, to a certain degree, and therefore bonding or adsorption of the silane coupling agent relates to the surface area of the whole inorganic filler. Accordingly, in the present invention, characteristics of the whole inorganic filler with which the silane coupling agent is bonded, the inorganic filler being formed in the flame-retardant silane master batch, are specified by the X value specified by Formula (I).

In the production method of the present invention, if the X value specified by Formula (I) falls within the range of 7 to 850, the flame-retardant crosslinked resin molded body having a combination of flame retardancy, appearance, mechanical characteristics and heat resistance can be produced.

A mechanism thereof is unknown yet, but it is assumed as described below.

In the step (1), the polyolefin-based resin is heat-kneaded with the inorganic filler and the silane coupling agent, in the presence of the organic peroxide, at a temperature equal to or higher than the decomposition temperature of the organic peroxide. Thereby, the organic peroxide is decomposed to generate radical, and grafting onto the polyolefin-based resin is caused by the silane coupling agent. In addition, a reaction of forming a chemical bond due to covalent bonding of the silane coupling agent with the group such as the hydroxyl group on the surface of the inorganic filler also partially occurs by heating on the above occasion.

More specifically, in the production method of the present invention, the inorganic filler and the silane coupling agent are used before kneading and/or during kneading with the polyolefin-based resin. Thus, the silane coupling agent is bonded with the inorganic filler by means of a hydrolyzable organic group such as an alkoxy group and is bonded with an uncrosslinked part of the polyolefin-based resin by means of an ethylenically unsaturated group, such as a vinyl group, existing at the other end, and kept thereon. Alternatively, the silane coupling agent is physically and chemically adsorbed onto pores or the surface of the inorganic filler, and kept thereon, without being bonded with the inorganic filler by means of the alkoxy group or the like. Thus, the present invention can form a silane coupling agent bonded with the inorganic filler by strong bonding (as the reason therefor, for example, formation of chemical bond with hydroxyl group or the like on the surface of the inorganic filler is considered), and a silane coupling agent bonded therewith by weak bonding (as the reason therefor, for example, interaction due to hydrogen bond, interaction between ions, partial electric charges, or dipoles, action due to adsorption, or the like is considered).

In this state, if the organic peroxide is added thereto and kneading is performed, at least two kinds of silane crosslinkable resins are formed in which the silane coupling agents having different bondings with the inorganic filler are graft reacted onto the polyolefin-based resin.

By the above kneading, among the silane coupling agents, the silane coupling agent having strong bonding with the inorganic filler keeps the bonding with the inorganic filler, and the crosslinkable group such as ethylenically unsaturated group is subjected to the grafting reaction onto a crosslinkable site in the polyolefin-based resin. In particular, when a plurality of the silane coupling agents are bonded on the surface of one inorganic filler particle through strong bonding, a plurality of the polyolefin-based resins are bonded through the inorganic filler particle. By these reactions or bondings, a crosslinked network through the inorganic filler spreads.

The X value specified by Formula (I) represents the surface area of the inorganic filler relative to the blending amount of the silane coupling agent which can be bonded with the surface. If the X value, namely, the surface area Yi of the inorganic filler which can be bonded with the silane coupling agent increases, the surface area of inorganic filler particles in a predetermined amount is large, and therefore a larger amount of the silane coupling agent can be bonded per unit surface area of the inorganic filler particles. Accordingly, even if the blending amount of the inorganic filler is reduced, the amount of the silane coupling agent which is bonded with the inorganic filler can be maintained. Thus, a crosslinking network by the inorganic filler is maintained, and the above-described excellent characteristics can be exhibited in the flame-retardant crosslinked resin molded body.

However, if the X value excessively decreases to a level less than 7, the silane grafting reaction does not smoothly progress in several cases. In addition thereto, pellets of the flame-retardant crosslinkable resin composition, or the flame-retardant crosslinked resin molded body is foamed, or aggregated substances or defects are generated in the flame-retardant crosslinked resin molded body to produce a problem in which the appearance is adversely affected.

On the other hand, if the X value excessively increases to a level over 850, the silane grafting reaction hardly progresses, and the flame-retardant crosslinked resin molded body is unable to be provided with the heat resistance at a high temperature (high-temperature heat resistance) and deformation resistance.

The X value specified by Formula (I) is preferably 10 to 450, further preferably 30 to 350, in view of resulting in producing the product having particularly excellent flame retardancy and heat resistance.

The X value specified by Formula (I) can be appropriately adjusted by the BET specific surface area or the blending amount of the inorganic filler, or the blending amount of the silane coupling agent.

In the step (1), the amount of incorporating the silanol condensation catalyst is not particularly limited and is preferably from 0.01 to 1 parts by mass, further preferably from 0.03 to 0.6 parts by mass, particularly preferably from 0.05 to 0.5 parts by mass, with respect to 100 parts by mass of the polyolefin-based resin. If the blending amount of the silanol condensation catalyst is within the above-described range, the crosslinking reaction sufficiently progresses, resulting in producing the product having excellent heat resistance (particularly, heat resistance at a high temperature) and deformability. Moreover, the reaction between the silane coupling agents can be suppressed, and gelation, the aggregated substances, and foaming by volatilization of the silane coupling agent can be suppressed.

In the step (1), a blending amount of other resins or the above-described additives each which can be used in addition to the above-described components can be appropriately set within the range in which the purpose of the present invention is not adversely affected.

It is preferable that the crosslinking assistant be not substantially mixed in the step (1). Herein, the term “is not substantially contained or is not substantially mixed” means that the crosslinking assistant is not actively added or mixed and it is not intended to exclude the crosslinking assistant which is inevitably contained or mixed.

The step (1) has the following steps (a) to (d). If the step (1) has these steps, each component can be uniformly melt-mixed, and the expected effect can be obtained.

Step (a): mixing the organic peroxide, the inorganic filler in which an X value specified by Formula (I) satisfies 7 to 850, and the silane coupling agent;

X=ΣA/B Formula (I)

(wherein, ΣA denotes a total amount of a product of a BET specific surface area (m²/g) of the inorganic filler and a blending amount of the inorganic filler, and B denotes a blending amount of the silane coupling agent.)

Step (b): melt-mixing the mixture obtained in the step (a) with a whole or part of the polyolefin-based resin at a temperature equal to or higher than a decomposition temperature of the organic peroxide.

Step (c): mixing the silanol condensation catalyst with, as a carrier resin, a resin different from the polyolefin-based resin or a remaining portion of the polyolefin-based resin.

Step (d): melt-mixing a melted mixture obtained in the step (b) with a mixture obtained in the step (c) at a temperature equal to or higher than a melting temperature of the polyolefin-based resin.

In the step (a), the organic peroxide, the inorganic filler (metal hydrate, and inorganic filler other than the metal hydrate as desired), the silane coupling agent, and other resins as desired, and the like are mixed in the above-described content. The mixing only needs be treatment according to which these components can be mixed, and specific examples include dry or wet mixing at a temperature lower than the decomposition temperature of the organic peroxide, for example, room temperature (25° C.), for about several minutes.

In the step (a), as long as the above temperature is kept, the polyolefin-based resin may be existed.

Subsequently, the above-described mixture and the whole or part of the polyolefin-based resin are melt-kneaded (also referred to as melt-mixed) while the mixture is heated by using a mixer such as the Banbury mixer (step (b)). Thus, the flame-retardant silane master batch can be obtained as a melted mixture.

The kneading temperature is a temperature equal to or higher than a decomposition temperature of the organic peroxide, and preferably 150 to 230° C. At this kneading temperature, the above-described component is melted, the organic peroxide decomposes and acts, and the silane grafting reaction required therefor progresses. Kneading conditions such as a kneading time can be appropriately set.

As a kneading method, a method ordinarily applied for rubber, plastic or the like may be applied. As a kneading device (mixer), for example, a single-screw extruder, a twin-screw extruder, a roll, a Banbury mixer, or various kneaders may be used.

In the present invention, in the step (step (a)) of preparing the above-described mixture, the melted mixture can be prepared by mixing, without being applied as a step different from the above-described melting and kneading step (step (b)), the organic peroxide, the inorganic filler, the silane coupling agent, the polyolefin-based resin and the like all together. For example, the step (a) can be performed as one step combined with the step (b) in which melt-mixing are performed by a kneader or the like. Specifically, each component to be used in the step (a) can be blended at an initial stage of the kneading step.

In both of the step (a) and the step (b), the above-mentioned each component is preferably mixed without mixing the silanol condensation catalyst. Thus, the condensation reaction of the silane coupling agent can be suppressed.

The silane master batch prepared in the step (b) contains at least two kinds of the silane crosslinkable resins (silane grafted polymers) in which the silane coupling agents are grafted onto the polyolefin-based resin.

In the present invention, differently from the step (a) and the step (b), the silanol condensation catalyst and the carrier resin are mixed (step (c)). Thus, a crosslinking promotion master batch is obtained. This mixing only needs be treatment capable of uniformly mixing the materials, and specific examples include mixing (melt-mixing) performed under melting of the carrier resin.

As the carrier resin, in a case where part of the polyolefin-based resin is used in the step (b), the remaining portion of the polyolefin-based resin can be used. In this case, the blending amount of the polyolefin-based resin in the step (b) is preferably 99 to 40 parts by mass, more preferably 98.5 to 60 parts by mass, while the blending amount of the polyolefin-based resin in the step (c) is preferably 1 to 60 parts by mass, more preferably 1.5 to 40 parts by mass. In the present invention, 100 parts by mass in total of the polyolefin-based resin used in both steps of the step (b) and the step (c) serve as a reference of the blending amount of each component.

On the other hand, in a case where the whole of the polyolefin-based resin is used in the step (b), a resin different therefrom can be used in the step (c). The different resin is not particularly limited, and specific examples include various resins. In this case, the blending amount of the other resin is preferably 1 to 50 parts by mass, more preferably 3 to 40 parts by mass, with respect to 100 parts by mass of the polyolefin-based resin.

If the blending amount of the carrier resin is excessively small, a crosslinking reaction does not smoothly progress, and a problem occurs on productivity in several cases. On the other hand, if the blending amount is excessively large, aggregated substances or defects are easily generated during molding.

The blending amount of the silanol condensation catalyst is as described above, and is appropriately determined according to the blending amount of the carrier resin.

In the production method of the present invention, subsequently, the melted mixture obtained in the step (b) (a flame-retardant silane master batch) and the mixture obtained in the step (c) (crosslinking promotion master batch) are melt-kneaded while heating them (step (d)). Thus, the flame-retardant crosslinkable resin composition can be obtained as a melted mixture.

A mixing temperature thereof may be a temperature equal to or higher than a melting temperature of the polyolefin-based resin or the carrier resin, and is preferably 150 to 230° C. At this temperature, the polyolefin-based resin and each component are melted, and the silanol condensation catalyst mainly acts thereon, and crosslinking necessary for the polyolefin-based resin can be occurred. Kneading conditions such as a kneading time can be appropriately set.

The melt-mixing can be performed in a manner similar to the melt-mixing in the step (b), for example.

In the step (1), the steps (a) to (d) can be simultaneously or successively performed.

The flame-retardant crosslinkable resin composition to be obtained contains at least two kinds of silane crosslinkable resins. This flame-retardant crosslinkable resin composition is an uncrosslinked body in which the silane coupling agent is not subjected to silanol condensation. Practically, under the melt-mixing in the step (d), partially crosslinking (partial crosslinking) is unavoidable, but at least moldability in molding in the step (2) is kept for the flame-retardant crosslinkable resin composition to be obtained.

In the method of producing a flame-retardant crosslinked resin molded body of the present invention, subsequently, the steps (2) and (3) are carried out. In other words, in the method of producing a flame-retardant crosslinked resin molded body of the present invention, the step (2) of obtaining a molded body by molding the mixture thus obtained is performed. The step (2) only has to mold the mixture, and the molding method and molding conditions can be appropriately selected depending on the form of the molded article of the present invention. Specific examples of the molding method include extrusion molding using an extruder, extrusion molding using an injection molding machine, and molding using other molding machines.

The step (2) can be carried out simultaneously or continuously with the step (d). More specifically, specific examples of one embodiment of the melt-mixing in the step (d) include an aspect in which the molding raw materials are melt-mixed upon the melting and molding, for example, upon the extrusion molding or immediately therebefore. For example, in a case where an insulated wire or the like is produced, a series of steps can be employed in which the molding materials of the flame-retardant silane master batch and the crosslinking promotion master batch are melt-kneaded in a coating device, and subsequently, for example, extruded and coated on the outer periphery of a conductor or the like, and molded into a desired shape.

In the molded body obtained in the step (2), the partial crosslinking is unavoidable in a manner similar to the flame-retardant crosslinkable resin composition, but the molded body is in a partially crosslinked state of holding the moldability according to which molding can be made in the step (2).

In the method of producing a flame-retardant crosslinked resin molded body of the present invention, a step (3) is carried out in which the molded body obtained in the step (2) is contacted with water. Thus, the flame-retardant crosslinked resin molded body in which the silane coupling agent is subjected to silanol condensation to cause crosslinking can be obtained.

In the step (3), the crosslinking can be promoted by applying moist heat treatment or warm water treatment to the molded body, or immersing the molded body into water at room temperature, or allowing the molded body to stand at room temperature, thereby hydrolyzing, by moisture, the silane coupling agent subjected to graft treatment to the polyolefin-based resin, to promote the crosslinking reaction. Contact conditions such as a contact time can be appropriately set.

Thus, the flame-retardant crosslinked resin molded body of the present invention is produced. This lame-retardant crosslinked resin molded body contains the resin component in which each of two kinds of silane crosslinkable resins is condensed through a siloxane bond, as described later.

Details of a reaction mechanism and the like in the production method of the present invention are unknown yet, but it is considered as described below.

More specifically, the polyolefin-based resin, if the resin is heated and kneaded, is crosslinked through a hydrolyzable silanol compound in the presence of organic peroxide. Only if a specific amount of the hydrolyzable silanol compound is blended in the polyolefin-based resin, a large amount of the inorganic filler can be blended without adversely affecting extrusion processability during molding, and the molded body can have both the heat resistance and the mechanical characteristics, even while securing the excellent flame retardancy.

Details of a mechanism according to which the inorganic filler mixed with the hydrolyzable silanol compound acts on the polyolefin-based resin are not clear yet, but the mechanism can be considered as described below.

More specifically, the hydrolyzable silanol compound is bonded onto a surface of the inorganic filler by mixing the hydrolyzable silanol compound with the inorganic filler. At this time, in the hydrolyzable silanol compound, a hydrolysable organic group such as an alkoxy group existing at one end is bonded with the inorganic filler, and various ethylenically unsaturated groups including a vinyl group existing at the other end are bonded with an uncrosslinked part of the polyolefin-based resin. Thus, a large amount of the inorganic filler can be blended without adversely affecting the extrusion processability. Furthermore, adhesion between the polyolefin-based resin and the inorganic filler is strengthened, and the flame-retardant crosslinked resin molded body having excellent mechanical strength and wear resistance, and difficulty in being scratched can be obtained.

In the present invention, the inorganic filler containing a specific amount of the metal hydrate is mixed with the polyolefin-based resin. Thus, the flame retardancy can be improved while maintaining the above-described excellent characteristics.

In addition, in the present invention, the BET specific surface area and the blending amount of the inorganic filler, and the blending amount of the silane coupling agent are adjusted to the specific range in which the X value specified by Formula (I) satisfies 7 to 850. Thereby being able to provide the flame-retardant crosslinked resin molded body and the flame-retardant crosslinkable resin composition with high heat resistance, and also the excellent mechanical characteristics and appearance, and further wear resistance and scratch resistance.

The production method of the present invention is applicable to production of a product (including a semi-finished product and a part) requiring the heat resistance, a product requiring the strength, a product requiring the flame retardancy, and a product such as a rubber material. Accordingly, the molded article of the present invention is processed into such a product. At this time, the molded article may be a molded article including the flame-retardant crosslinked resin molded body, or may be a molded article consisting of the flame-retardant crosslinked resin molded body.

The flame-retardant crosslinked resin molded body of the present invention is not limited in a shape thereof, and can be used as the molded article such as an electric wire power source plug, a connector, a sleeve, a box, a tape base material, a tube, a sheet, a wiper, vibration-proof rubber, an automobile mechanism component, an automobile interior material, a building material, a sealant, and a wiring material used in internal and external wiring of an electric or electronic apparatus, an insulator of an electric wire, and a sheath thereof.

Such a molded article can be produced by performing extrusion coating of the flame-retardant crosslinkable resin composition of the present invention around a conductor or around a conductor formed by longitudinally lapping or intertwisting tensile strength fibers by using a general-purpose extrusion coating machine. For example, as the conductor, a single wire, a stranded wire or the like of annealed copper can be used. Moreover, as the conductor, in addition to a bare wire, a tin-plated material or a material having an enamel-coated insulation layer may be used. A temperature in the extrusion coating machine at this time is preferably adjusted to about 180° C. in a cylinder zone, and about 200° C. in a crosshead zone. A thickness of the insulation layer (coating layer formed of the flame-retardant crosslinked resin molded body of the present invention) formed around the conductor is not particularly limited, but is ordinarily about 0.15 to about 5 mm.

### EXAMPLES

The present invention is described in more detail based on examples given below, but the present invention is not limited by the following examples.

In addition, in Table 1 to Table 4, the numerical values for incorporated amounts of the respective Examples and Comparative Examples are in terms of part by mass.

With regard to Examples 1 to 22 and Comparative Examples 1 to 7 each, operation was carried out by using the following components, and setting respective specifications to conditions shown in Table 1 to Table 4 each, and evaluations to be described later were carried out.

The details of each compounds in tables 1 to 4 are described below.

### <Polyolefin-Based Resin>

### (Polyethylene: PE)

“EVOLVE SP0540F” (trade name, manufactured by Prime Polymer Co., Ltd., linear metallocene polyethylene (LLDPE))

“UE320” (NOVATEC PE (trade name), manufactured by Japan Polyethylene Corporation, linear low-density polyethylene (LLDPE))
(Ethylene-vinyl acetate copolymer: EVA)
“V5274” (EVAFLEX V5274 (trade name), ethylene-vinyl acetate copolymer resin, content of VA: 17 mass %, manufactured by Dupont-Mitsui Polychemicals Co., Ltd.)

### (Polypropylene: PP)

“PB222A” (trade name, manufactured by SunAllomer Ltd., random polypropylene)
(Ethlylene propylene diene rubber: EPDM)
“NORDEL IP-4760P” (trade name, manufactured by Dow Chemical Japan Ltd.)
“NORDEL IP-4520P” (trade name, manufactured by Dow Chemical Japan Ltd.) (Styrene-based elastomer: SEPS)
“SEPTON 4077” (trade name, manufactured by Kuraray Co., Ltd., SEPS, content of styrene: 30 mass %)

### (Oil)

“DIANA PROCESS OIL PW-90” (trade name, manufactured by Idemitsu Kosan Co., Ltd., paraffin oil)

### <Metal Hydrate>

“KISUMA 5AL” (trade name, manufactured by Kyowa Chemical Industry Co., Ltd., magnesium hydroxide, BET specific surface area Yi: 5 m²/g)
“MAGSEEDS LN-6” (trade name, manufactured by Konoshima Chemical Co., Ltd., magnesium hydroxide, BET specific surface area Yi: 5 m²/g)
“MAGSEEDS X-6F” (trade name, manufactured by Konoshima Chemical Co., Ltd., magnesium hydroxide, BET specific surface area Yi: 8 m²/g)
“KISUMA 5L” (trade name, manufactured by Kyowa Chemical Industry Co., Ltd., BET specific surface area Yi: 5.8 m²/g)

“Higilite H42M” (trade name, manufactured by SHOWA DENKO K.K., Aluminium hydroxide, BET specific surface area Yi: 5 m²/g)

“Boehmite” (trade name, manufactured by Konoshima Chemical Co., Ltd.,
Aluminium oxide monohydrate, BET specific surface area Yi: 5 m²/g)
<Inorganic Filler Other than the Metal Hydrate>
“Aerosil 200” (trade name, manufactured by Japan Aerosil corporation, hydrophilic fumed silica, amorphous silica, BET specific surface area Yi: 200
“CRYSTALITE 5X” (trade name, manufactured by Tatsumori Ltd., crystalline silica, BET specific surface area Yi: 12 m²/g)
“Softon 1200” (trade name, manufactured by BIHOKU FUNKA KOGYO CO., LTD., calcium carbonate, BET specific surface area Yi: 1.2 m²/g)
“Softon 2200” (trade name, manufactured by BIHOKU FUNKA KOGYO CO., LTD., calcium carbonate, BET specific surface area Yi: 2.2 m²/g)

### <Silane Coupling Agent>

“KBM1003” (trade name, manufactured by Shin-Etsu Chemical Co., Ltd., Vinyltrimethoxysilane)

### <Organic Peroxide>

“PERHEXA 25B” (trade name, manufactured by NOF CORPORATION., 2,5-dimethyl-2,5-di(tert-butylperoxy)hexane, temperature of decomposition: 149° C.)

### <Silanol Condensation Catalyst>

“ADKSTAB OT-1” (trade name, manufactured by ADEKA CORPORATION, dioctyltin dilaurate)

### <Antioxidant>

“IRGANOX 1010” (trade name, manufactured by BASF, pentaerythritol tetrakis [3-(3,5-di-tert-butyl-4-hydroxyphenyl)propionate])

### Examples 1 to 22 and Comparative Examples 1 to 7

In each Example, part of a polyolefin-based resin (25 parts by mass based on a total amount of the polyolefin-based resin) was used as a carrier resin of a crosslinking promotion master batch (may be referred to as a crosslinking promotion MB in several cases). As this carrier resin, polyethylene “UE320” being one of resin components which constitute the polyolefin-based resin was applied.

First, a silane coupling agent and organic peroxide were mixed at room temperature (25° C.) in blending proportions shown in a column “composition P (the composition of the flame-retardant silane master batch)” in Table 1 to Table 4 each. Then, a polyolefin-based resin, a metal hydrate, an inorganic filler other than the metal hydrate, and an antioxidant were charged into a 2 L Banbury mixer manufactured by Nippon Roll MFG. Co. Ltd., and then a blend of the silane coupling agent and the organic peroxide was put into the mixer. Then, a silane MB was obtained by mixing the charged components at room temperature (25° C.) in the Banbury mixer, followed by melt-mixing the resultant material at a material discharge temperature of 180° C. to 190° C. and at a revolution speed of 35 rpm for about 15 minutes to be obtained the flame-retardant silane master batch (may be referred to as a flame-retardant silane MB in several cases).

The silane MB obtained in the Examples 1 to 22 contains at least two kinds of silane crosslinkable resins in which silane coupling agents were graft reacted onto the polyolefin-based resin.

The column “composition P” in Table 1 to Table 4 each shows, in addition to the blending amount of each component, an X value specified by Formula (I), and the like.

Next, the components shown in the column “composition Q (the composition of the crosslinking promotion MB) in Table 1 to Table 4 each were mixed by the Banbury mixer in blending proportions shown in the column “composition Q” in Table 1 to Table 4 each, and then melt and mixed the resultant material at a material discharge temperature of 180 to 190° C., and thus the crosslinking promotion MB was obtained.

Next, the silane MB and the crosslinking promotion MB were dry-blended in blending proportions shown in a column “mixing ratio” in Table 1 to Table 4 each, and the resultant blend was introduced into a 40 mm extruder in which L/D=24 (a compression zone screw temperature: 190° C., a head temperature: 200° C.), and while the blend was melt-mixed in an extruder screw, was molded into two kinds of sheet-shaped molded bodies each having a thickness of 1 mm and 2 mm by T-die extrusion.

Moreover, an electric wire having an outer diameter of 2.8 mm was obtained, in a similar manner, by introducing pellets obtained by dry blending the silane MB and the crosslinking promotion MB into the 40 mm extruder in which L/D=24 (compressing zone screw temperature: 190° C., head temperature: 200° C.), and coating the resultant material on an outside of a 1/0.8 TA conductor at a thickness of 1 mm.

The thus-obtained two kinds of the sheet-shaped molded bodies and the electric wire were allowed to stand for 24 hours under an atmosphere of a temperature of 80° C. and a humidity of 95%. Thus, sheets formed of the flame-retardant crosslinked resin molded body, respectively, and an insulated wire having the flame-retardant crosslinked resin molded body as a coating were produced.

In addition, in all of the two kinds of sheets and the insulated wire produced in Comparative Example 1, the flame-retardant crosslinked resin molded bodies were foamed.

The sheets and the electric wires thus manufactured were subjected to the following evaluation, and the results thereof are shown in Tables 1 to 4.

### <Mechanical Property>

A tensile test was conducted on the sheet having a thickness of 1 mm produced in each Example. This tensile test was conducted, based on JIS K 6723, by using a JIS No. 3 dumbbell test specimen prepared by punching the flame-retardant crosslinked resin molded body sheet. Tensile strength (MPa) and elongation (%) were measured by conducting the test at a measuring temperature of 25° C., a gauge length of 20 mm and a tensile speed of 20 mm/min.

A case where the tensile strength is 10 MPa or more is deemed to be passable in the present test, and a case where the elongation is 200% or more is deemed to be passable in the present test.

### <Heating Deformation Test (Sheet)>

The following heating deformation test was conducted as heat resistance of the sheet formed of the flame-retardant crosslinked resin molded body. As this heating deformation test, a heating deformation ratio was measured on the sheet having a thickness of 2 mm, based on the “heating deformation test” specified in JIS K 6723, under conditions of a measuring temperature of 120° C. and a load of 5 N.

As an evaluation, a case where the heating deformation ratio is 40% or less is deemed to be passable in the present test, and a case where the ratio is over 40% is deemed to be not passable in the present test (expressed by “C” in Table 1 to Table 4).

In Table 1 to Table 4, with regard to the results of the heating deformation test of the sheet, the following evaluation symbols are simultaneously described in addition to the heating deformation ratios. As the evaluation symbols, a case where the heating deformation ratio is deemed to be not passable is expressed by “C,” a case where the heating deformation ratio is over 35% and 40% or less is expressed by “B,” a case where the heating deformation ratio is over 30% and 35% or less is expressed by “A,” and a case where the heating deformation ratio is 30% or less is expressed by “AA.”

### <Extrusion Appearance Characteristics of the Insulated Wire>

Extrusion appearance characteristics of the insulated wire were evaluated by observing extrusion appearance upon producing the insulated wire.

Specifically, upon extruding a melted mixture of silane MB and crosslinking promotion MB at a linear speed of 15 m/min in an extruder having a screw diameter of 40 mm, the insulated wire in which appearance was good (no aggregated substances or defects were observed with the naked eye) was taken as “A,” the insulated wire in which aggregated substances or defects were observed with the naked eye but which insulated wire can be used was taken as “B,” and the insulated wire in which appearance was remarkably bad (in which a number of the aggregated substances or defects were observed with the naked eye and which insulated wire can't be used) was taken as “C.” “A” and “B” are deemed to be passable in the present test.

### <Heating Deformation Test (Electric Wire)>

The following heating deformation test was conducted as heat resistance of the electric wire formed of the flame-retardant crosslinked resin molded. In this heating deformation test, a reduction in thickness of the insulated wire was measured, based on JIS C 3005, under conditions of a measuring temperature of 120° C. and a load of 5 N.

As an evaluation, a case where the reduction ratio is 40% or less is deemed to be passable in the present test, and a case where the ratio is over 40% is deemed to be not passable in the present test

In Table 1 to Table 4, with regard to the results of the heating deformation test of the electric wire, the following evaluation symbols are simultaneously described in addition to the reduction ratios. As the evaluation symbols, a case where the reduction ratio is deemed to be not passable is expressed by “C,” a case where the reduction ratio is over 35% and 40% or less is expressed by “B,” a case where the reduction ratio is over 30% and 35% or less is expressed by “A,” and a case where the reduction ratio is 30% or less is expressed by “AA.”

### <Hot Set Test>

A hot set test was conducted as the heat resistance of the electric wire. In the hot set test, a tube test piece of the insulated wire was prepared in a manner similar to production of the insulated wire in each Example. An evaluation line having a length of 50 mm was marked on this tube test piece, and then a weight of 117 g was attached thereto, and the resultant test piece was allowed to stand in a constant-temperature chamber at 180° C. for 15 minutes. Then, the tube test piece was removed from the constant-temperature chamber, and a length after allowing the test piece to stand was measured to determine elongation (%).

In Table 1 to Table 4, as the results of the hot set, 100% or less was deemed to be a passable level.

The present test is shown for reference.

### <Flame Retardancy Test>

As a flame retardancy test of the electric wire, a 60° inclined flame retardancy test was conducted based on JIS C 3005. The test was conducted 3 times on the insulated wire in each Example, and the insulated wire in which flames were extinguished in all was deemed to be passable.

TABLE 1

| | | | | | Examples | | | | | | |
|---|---|---|---|---|---|---|---|---|---|---|---|
| | | | | | 1 | 2 | 3 | 4 | 5 | 6 | 7 |
| Compo- | Polyolefin | PE | EVOLUE SP0540F | | 15 | 15 | 15 | 15 | 15 | 15 | 15 |
| sition | based | | UE320 | | | | | | | | |
| P | resin | EVA | V5274 | | | | | | | | |
| | | PP | PB222A | | 5 | 5 | 5 | 5 | 5 | 5 | 5 |
| | | EPDM | NORDEL IP-4760P | | 25 | | 25 | 25 | 25 | 25 | 25 |
| | | | NORDEL IP-4520P | | 10 | | 10 | 10 | 10 | 10 | 10 |
| | | SEPS | SEPTON 4077 | | | 30 | | | | | |
| | | OIL | DIANA PROCESS | | 20 | 25 | 20 | 20 | 20 | 20 | 20 |
| | | | PW-90 | | | | | | | | |
| | Inorganic filler | | | Yi | | | | | | | |
| | | | | (m²/g) | | | | | | | |
| | Metal | Magne- | KISUMA 5AL | 5 | | | | | | | |
| | hydroxide | sium | MAGSEEDS LN-6 | 5 | | | 120 | | | | |
| | | hydrox- | MAGSEEDS X-6F | 8 | | | | | | | |
| | | ide | KISUMA 5L | 5.8 | 30 | 60 | | 250 | 250 | 300 | 300 |
| | | Alumi- | Higilite H42M | 5 | | | | | | | |
| | | num | | | | | | | | | |
| | | hydrox- | | | | | | | | | |
| | | ide | | | | | | | | | |
| | | Boehm- | | 5 | | | | | | | |
| | | ite | | | | | | | | | |
| | Inorganic | Silica | Aerosil 200 | 200 | 1 | 1 | 1 | 1 | | 4 | |
| | Filler | | CRYSTALITE 5X | 12 | | | | | | | |
| | other than | Calcium | Softon 1200 | 1.2 | | | | | | | |
| | the metal | carbon- | Softon 2200 | 2.2 | | | | | | | |
| | hydrate | ate | | | | | | | | | |

| | Total blending amount of metal hydroxide | | 30 | 60 | 120 | 250 | 250 | 300 | 300 |
|---|---|---|---|---|---|---|---|---|---|
| | (parts by mass) | | | | | | | | |
| | Total blending amount of inorganic filler | | 31 | 61 | 121 | 251 | 250 | 304 | 300 |
| | (parts by mass) | | | | | | | | |
| | Silane coupling | KBM1003 | 6 | 8 | 6 | 5 | 3 | 4 | 4 |
| | agent | | | | | | | | |
| | Organic peroxide | PERHEXA 25B | 0.1 | 0.1 | 0.1 | 0.1 | 0.1 | 0.1 | 0.1 |
| | Antioxidant | IRGANOX 1010 | 0.1 | 0.1 | 0.1 | 0.1 | 0.1 | 0.1 | 0.1 |
| | Total (parts by mass) | | 112.2 | 144.2 | 202.2 | 331.2 | 328.2 | 383.2 | 379.2 |
| | Formula (I) | ΣA | 374 | 548 | 800 | 1650 | 1450 | 2540 | 1740 |
| | | X | 62.3 | 68.5 | 133.3 | 330.0 | 483.3 | 635.0 | 435.0 |
| Compo- | PE | UE320 | 25 | 25 | 25 | 25 | 25 | 25 | 25 |
| sition | Silanol | ADKSTAB OT-1 | 0.2 | 0.2 | 0.2 | 0.2 | 0.2 | 0.2 | 0.2 |
| Q | condensation | | | | | | | | |
| | catalyst | | | | | | | | |
| | Antioxidizing | IRGANOX 1010 | 1 | 1 | 1 | 1 | 1 | 1 | 1 |
| | agent | | | | | | | | |
| | Total (parts by mass) | | 26.2 | 26.2 | 26.2 | 26.2 | 26.2 | 26.2 | 26.2 |
| Mixing | Composition P | Mixing amount | 112.2 | 144.2 | 202.2 | 331.2 | 328.2 | 383.2 | 379.2 |
| ratio | | (parts by mass) | | | | | | | |
| | Composition Q | Mixing amount | 26.2 | 26.2 | 26.2 | 26.2 | 26.2 | 26.2 | 26.2 |
| | | (parts by mass) | | | | | | | |
| | Total (parts by mass) | | 138.4 | 170.4 | 228.4 | 357.4 | 354.4 | 409.4 | 405.4 |
| Evaluation | Tensile strength | Mpa | 17.2 | 17.9 | 16.7 | 14.2 | 12.1 | 10.6 | 11 |
| of sheet | Elongation | % | 530 | 518 | 410 | 330 | 340 | 280 | 310 |
| | Heating | % | 16 | 15 | 14 | 16 | 22 | 35 | 24 |
| | deformation | Evaluation | AA | AA | AA | AA | AA | A | AA |
| | ratio | symbol | | | | | | | |
| Evalutaion | appearance characteristics | | A | A | A | A | A | A | A |
| of insulated | Heating | % | 18 | 17 | 17 | 27 | 31 | 39 | 31 |
| wire | deformation | Evaluation | AA | AA | AA | AA | AA | AA | AA |
| | ratio | symbol | | | | | | | |

| | | | | | | | |
|---|---|---|---|---|---|---|---|
| Flame retardancy test | passed | passed | passed | passed | passed | passed | passed |
| Hot set test | passed | passed | passed | passed | passed | not | passed |
| | | | | | | passed | |

TABLE 2

| | | | | | Examples | | | | | | |
|---|---|---|---|---|---|---|---|---|---|---|---|
| | | | | | 8 | 9 | 10 | 11 | 12 | 13 | 14 |
| Compo- | Polyolefin | PE | EVOLUE SP0540F | | 15 | 15 | 15 | 15 | 15 | 15 | 15 |
| sition | based | | UE320 | | | | | | | | |
| P | resin | EVA | V5274 | | | | | | | | |
| | | PP | PB222A | | 5 | 5 | 5 | 5 | 5 | 5 | 5 |
| | | EPDM | NORDEL IP-4760P | | 25 | 25 | 25 | 25 | 25 | | |
| | | | NORDEL IP-4520P | | 10 | 10 | 10 | 10 | 10 | | |
| | | SEPS | SEPTON 4077 | | | | | | | 30 | 30 |
| | | OIL | DIANA PROCESS | | 20 | 20 | 20 | 20 | 20 | 25 | 25 |
| | | | PW-90 | | | | | | | | |
| | Inorganic filler | | | Yi | | | | | | | |
| | | | | (m²/g) | | | | | | | |
| | Metal | Magne- | KISUMA 5AL | 5 | | | | | | | |
| | hydroxide | sium | MAGSEEDS LN-6 | 5 | | 20 | 20 | | | 150 | |
| | | hydrox- | MAGSEEDS X-6F | 8 | 60 | | | | | | 220 |
| | | ide | KISUMA 5L | 5.8 | | | | | | | |
| | | Alumi- | Higilite H42M | 5 | | | | 20 | 20 | | |
| | | num | | | | | | | | | |
| | | hydrox- | | | | | | | | | |
| | | ide | | | | | | | | | |
| | | Boehm- | | 5 | | | | | | | |
| | | ite | | | | | | | | | |
| | Inorganic | Silica | Aerosil 200 | 200 | | 4 | | 10 | | | |
| | Filler | | CRYSTALITE 5X | 12 | 40 | | | | | | |
| | other than | Calcium | Softon 1200 | 1.2 | | 30 | 30 | 60 | 60 | | |
| | the metal | carbon- | Softon 2200 | 2.2 | | | | | | | |
| | hydrate | ate | | | | | | | | | |

| | Total blending amount of metal hydroxide | | 60 | 20 | 20 | 20 | 20 | 150 | 220 |
|---|---|---|---|---|---|---|---|---|---|
| | (parts by mass) | | | | | | | | |
| | Total blending amount of inorganic filler | | 100 | 54 | 50 | 90 | 80 | 150 | 220 |
| | (parts by mass) | | | | | | | | |
| | Silane coupling | KBM1003 | 3 | 14 | 14 | 14 | 14 | 10 | 4 |
| | agent | | | | | | | | |
| | Organic peroxide | PERHEXA 25B | 0.1 | 0.2 | 0.1 | 0.15 | 0.15 | 0.1 | 0.1 |
| | Antioxidant | IRGANOX 1010 | 0.1 | 0.1 | 0.1 | 0.1 | 0.1 | 0.1 | 0.1 |
| | Total (parts by mass) | | 178.2 | 143.3 | 139.2 | 179.25 | 169.25 | 235.2 | 299.2 |
| | Formula (I) | ΣA | 960 | 936 | 136 | 2172 | 172 | 750 | 1760 |
| | | X | 320.0 | 66.9 | 9.7 | 155.1 | 12.3 | 75.0 | 440.0 |
| Compo- | PE | UE320 | 25 | 25 | 25 | 25 | 25 | 25 | 25 |
| sition | Silanol | ADKSTAB OT-1 | 0.2 | 0.2 | 0.2 | 0.2 | 0.2 | 0.2 | 0.2 |
| Q | condensation | | | | | | | | |
| | catalyst | | | | | | | | |
| | Antioxidizing | IRGANOX 1010 | 1 | 1 | 1 | 1 | 1 | 1 | 1 |
| | agent | | | | | | | | |
| | Total (parts by mass) | | 26.2 | 26.2 | 26.2 | 26.2 | 26.2 | 26.2 | 26.2 |
| Mixing | Composition P | Mixing amount | 178.2 | 143.3 | 139.2 | 179.25 | 169.25 | 235.2 | 299.2 |
| ratio | | (parts by mass) | | | | | | | |
| | Composition Q | Mixing amount | 26.2 | 26.2 | 26.2 | 26.2 | 26.2 | 26.2 | 26.2 |
| | | (parts by mass) | | | | | | | |
| | Total (parts by mass) | | 204.4 | 169.5 | 165.4 | 205.45 | 195.45 | 261.4 | 325.4 |
| Evaluation | Tensile strength | Mpa | 14.7 | 15.3 | 14.7 | 15.6 | 15.9 | 14.2 | 11.5 |
| of sheet | Elongation | % | 290 | 582 | 626 | 430 | 591 | 390 | 347 |
| | Heating | % | 22 | 17 | 32 | 15 | 33 | 9 | 16 |
| | deformation | Evaluation | AA | AA | AA | AA | AA | AA | AA |
| | ratio | symbol | | | | | | | |
| Evaluation | appearance characteristics | | A | A | B | A | B | A | A |
| of insulated | Heating | % | 30 | 18 | 35 | 17 | 34 | 16 | 26 |
| wire | deformation | Evaluation | AA | AA | A | AA | AA | AA | AA |
| | ratio | symbol | | | | | | | |

| | | | | | | | |
|---|---|---|---|---|---|---|---|
| Flame retardancy test | passed | passed | passed | passed | passed | passed | passed |
| Hot set test | passed | passed | not | passed | not | passed | passed |
| | | | passed | | passed | | |

TABLE 3

| | | | | | Examples | | | | | | | |
|---|---|---|---|---|---|---|---|---|---|---|---|---|
| | | | | | 15 | 16 | 17 | 18 | 19 | 20 | 21 | 22 |
| Compo- | Polyolefin | PE | EVOLUE SP0540F | | 15 | 15 | 15 | 15 | 40 | 50 | 15 | 15 |
| sition | based | | UE320 | | | | | | | 10 | | |
| P | resin | EVA | V5274 | | | | | | 15 | | | |
| | | PP | PB222A | | 5 | 5 | 5 | 5 | 20 | 15 | 15 | 15 |
| | | EPDM | NORDEL IP-4760P | | | | | | | | | |
| | | | NORDEL IP-4520P | | | | | | | | | |
| | | SEPS | SEPTON 4077 | | 30 | 30 | 30 | 30 | | | 25 | 25 |
| | | OIL | DIANA PROCESS | | 25 | 25 | 25 | 25 | | | 20 | 20 |
| | | | PW-90 | | | | | | | | | |
| | Inorganic filler | | | Yi | | | | | | | | |
| | | | | (m²/g) | | | | | | | | |
| | Metal | Magne- | KISUMA 5AL | 5 | | 100 | | | | | | |
| | hydroxide | sium | MAGSEEDS LN-6 | 5 | | | | | | 100 | 100 | 100 |
| | | hydrox- | MAGSEEDS X-6F | 8 | 140 | | | 240 | 100 | | | |
| | | ide | KISUMA 5L | 5.8 | 140 | | | | | | | |
| | | Alumi- | Higilite H42M | 5 | | 100 | | | | | | |
| | | num | | | | | | | | | | |
| | | hydrox- | | | | | | | | | | |
| | | ide | | | | | | | | | | |
| | | Boehm- | | 5 | | | 100 | | | | | |
| | | ite | | | | | | | | | | |
| | Inorganic | Silica | Aerosil 200 | 200 | | | | | | | | |
| | Filler | | CRYSTALITE 5X | 12 | | | | | | | | |
| | other than | Calcium | Softon 1200 | 1.2 | | | | | | | | |
| | the metal | carbon- | Softon 2200 | 2.2 | | | | | | | | |
| | hydrate | ate | | | | | | | | | | |

| | Total blending amount of metal hydroxide | | 280 | 200 | 100 | 240 | 100 | 100 | 100 | 100 |
|---|---|---|---|---|---|---|---|---|---|---|
| | (parts by mass) | | | | | | | | | |
| | Total blending amount of inorganic filler | | 280 | 200 | 100 | 240 | 100 | 100 | 100 | 100 |
| | (parts by mass) | | | | | | | | | |
| | Silane coupling | KBM1003 | 3 | 6 | 6 | 15 | 5 | 5 | 5 | 5 |
| | agent | | | | | | | | | |
| | Organic peroxide | PERHEXA 25B | 0.1 | 0.1 | 0.1 | 0.1 | 0.08 | 0.08 | 0.5 | 0.05 |
| | Antioxidant | IRGANOX 1010 | 0.1 | 0.1 | 0.1 | 0.1 | 0.1 | 0.1 | 0.1 | 0.1 |
| | Total (parts by mass) | | 358.2 | 281.2 | 181.2 | 330.2 | 180.18 | 180.18 | 180.6 | 180.15 |
| | Formula (I) | ΣA | 1932 | 1000 | 500 | 1920 | 800 | 500 | 500 | 500 |
| | | X | 644.0 | 166.7 | 83.3 | 128.0 | 160.0 | 100.0 | 100.0 | 100.0 |
| Compo- | PE | UE320 | 25 | 25 | 25 | 25 | 25 | 25 | 25 | 25 |
| sition | Silanol | ADKSTAB OT-1 | 0.2 | 0.2 | 0.2 | 0.2 | 0.2 | 0.5 | 0.2 | 0.5 |
| Q | condensation | | | | | | | | | |
| | catalyst | | | | | | | | | |
| | Antioxidizing | IRGANOX 1010 | 1 | 1 | 1 | 1 | 1 | 1 | 1 | 1 |
| | agent | | | | | | | | | |
| | Total (parts by mass) | | 26.2 | 26.2 | 26.2 | 26.2 | 26.2 | 26.5 | 26.2 | 26.5 |
| Mixing | Composition P | Mixing amount | 358.2 | 281.2 | 181.2 | 330.2 | 180.18 | 180.18 | 180.6 | 180.15 |
| ratio | | (parts by mass) | | | | | | | | |
| | Composition Q | Mixing amount | 26.2 | 26.2 | 26.2 | 26.2 | 26.2 | 26.5 | 26.2 | 26.5 |
| | | (parts by mass) | | | | | | | | |
| | Total (parts by mass) | | 384.4 | 307.4 | 207.4 | 356.4 | 206.38 | 206.68 | 206.8 | 206.65 |
| Evaluation | Tensile strength | Mpa | 10.3 | 16.3 | 14.2 | 12.3 | 15.8 | 19.9 | 14.2 | 19.9 |
| of sheet | | | | | | | | | | |
| | Elongation | % | 240 | 310 | 300 | 330 | 290 | 357 | 210 | 357 |
| | Heating | % | 32 | 15 | 17 | 13 | 9 | 11 | 8 | 28 |
| | deformation | Evaluation | AA | AA | AA | AA | AA | AA | AA | AA |
| | ratio | symbol | | | | | | | | |
| Evaluation | appearance characteristics | | A | A | A | A | A | A | B | A |
| of insulated | Heating | % | 37 | 25 | 26 | 21 | 13 | 14 | 13 | 36 |
| wire | deformation | Evaluation | A | AA | AA | AA | AA | AA | AA | A |
| | ratio | symbol | | | | | | | | |

| | | | | | | | | |
|---|---|---|---|---|---|---|---|---|
| Flame retardancy test | passed | passed | passed | passed | passed | passed | passed | passed |
| Hot set test | not | passed | passed | passed | passed | passed | passed | not |
| | passed | | | | | | | passed |

TABLE 4

| | | | | | Comparative Examples | | | | | | |
|---|---|---|---|---|---|---|---|---|---|---|---|
| | | | | | 1 | 2 | 3 | 4 | 5 | 6 | 7 |
| Compo- | Polyolefin | PE | EVOLUE SP0540F | | 15 | 15 | 15 | 15 | 15 | 15 | 15 |
| sition | based | | UE320 | | | | | | | | |
| P | resin | EVA | V5274 | | | | | | | | |
| | | PP | PB222A | | 5 | 5 | 5 | 5 | 5 | 5 | 5 |
| | | EPDM | NORDEL IP-4760P | | | | | | | 25 | 25 |
| | | | NORDEL IP-4520P | | | | | | | 10 | 10 |
| | | SEPS | SEPTON 4077 | | 30 | 30 | 30 | 30 | 30 | | |
| | | OIL | DIANA PROCESS | | 25 | 25 | 25 | 25 | 25 | 20 | 20 |
| | | | PW-90 | | | | | | | | |
| | Inorganic filler | | | Yi | | | | | | | |
| | | | | (m²/g) | | | | | | | |
| | Metal | Magne- | KISUMA 5AL | 5 | | | | | | | |
| | hydroxide | sium | MAGSEEDS LN-6 | 5 | 10 | | | | | | 15 |
| | | hydrox- | MAGSEEDS X-6F | 8 | | | | | | | |
| | | ide | KISUMA 5L | 5.8 | | 100 | 330 | 70 | | | |
| | | Alumi- | Higilite H42M | 5 | | | | | | | |
| | | num | | | | | | | | | |
| | | hydrox- | | | | | | | | | |
| | | ide | | | | | | | | | |
| | | Boehm- | | 5 | | | | | | | |
| | | ite | | | | | | | | | |
| | Inorganic | Silica | Aerosil 200 | 200 | | 11 | | | | 12 | 4 |
| | Filler | | CRYSTALITE 5X | 12 | | | | | | | |
| | other than | Calcium | Softon 1200 | 1.2 | | | | | 30 | | 30 |
| | the metal | carbon- | Softon 2200 | 2.2 | | | | | | | |
| | hydrate | ate | | | | | | | | | |

| | Total blending amount of metal hydroxide | | 10 | 100 | 330 | 70 | 0 | 0 | 15 |
|---|---|---|---|---|---|---|---|---|---|
| | (parts by mass) | | | | | | | | |
| | Total blending amount of inorganic filler | | 10 | 111 | 330 | 70 | 30 | 12 | 49 |
| | (parts by mass) | | | | | | | | |
| | Silane coupling | KBM1003 | 11 | 2 | 2 | 1.5 | 8 | 2 | 7 |
| | agent | | | | | | | | |
| | Organic peroxide | PERHEXA 25B | 0.1 | 0.1 | 0.1 | 0.1 | 0.1 | 0.1 | 0.2 |
| | Antioxidant | IRGANOX 1010 | 0.1 | 0.1 | 0.1 | 0.1 | 0.1 | 0.1 | 0.1 |
| | Total (parts by mass) | | 96.2 | 188.2 | 407.2 | 146.7 | 113.2 | 89.2 | 131.3 |
| | Formula (I) | ΣA | 50 | 2780 | 1914 | 406 | 36 | 2400 | 911 |
| | | X | 4.5 | 1390.0 | 957.0 | 270.7 | 4.5 | 1200.0 | 130.1 |
| Compo- | PE | UE320 | 25 | 25 | 25 | 25 | 25 | 25 | 25 |
| sition | Silanol | ADKSTAB OT-1 | 0.2 | 0.2 | 0.2 | 0.2 | 0.2 | 0.2 | 0.2 |
| Q | condensation | | | | | | | | |
| | catalyst | | | | | | | | |
| | Antioxidizing | IRGANOX 1010 | 1 | 1 | 1 | 1 | 1 | 1 | 1 |
| | agent | | | | | | | | |
| | Total (parts by mass) | | 26.2 | 26.2 | 26.2 | 26.2 | 26.2 | 26.2 | 26.2 |
| Mixing | Composition P | Mixing amount | 96.2 | 188.2 | 407.2 | 146.7 | 113.2 | 89.2 | 131.3 |
| ratio | | (parts by mass) | | | | | | | |
| | Composition Q | Mixing amount | 26.2 | 26.2 | 26.2 | 26.2 | 26.2 | 26.2 | 26.2 |
| | | (parts by mass) | | | | | | | |
| | Total (parts by mass) | | 122.4 | 214.4 | 433.4 | 172.9 | 139.4 | 115.4 | 157.5 |
| Evaluation | Tensile strength | Mpa | 8.6 | 13.8 | 8.3 | 15.8 | 14.2 | 18.1 | 16.2 |
| of sheet | Elongation | % | 360 | 240 | 100 | 383 | 300 | 313 | 612 |
| | Heating | % | 41 | 71 | 64 | 65 | 42 | 48 | 17 |
| | deformation | Evaluation | C | C | C | C | C | C | AA |
| | ratio | symbol | | | | | | | |
| Evaluation of | appearance characteristics | | A | A | C | C | A | A | A |
| insulated | Heating | % | 52 | 77 | 83 | 74 | 58 | 62 | 18 |
| wire | deformation | Evaluation | C | C | C | C | C | C | AA |
| | ratio | symbol | | | | | | | |

| | | | | | | | |
|---|---|---|---|---|---|---|---|
| Flame retardancy test | not | passed | passed | passed | not | not | not |
| | passed | | | | passed | passed | passed |
| Hot set test | not | not | not | not | not | not | passed |
| | passed | passed | passed | passed | passed | passed | |

The following is found from the results in Table 1 to Table 4.

According to all of Examples 1 to 22, the sheet formed of the flame-retardant crosslinked resin molded body and having a combination of the excellent flame retardancy, heat resistance, appearance, and mechanical characteristics, and the insulated wire having the coating formed of this flame-retardant crosslinked resin molded body could be produced.

Moreover, if the inorganic filler containing the metal hydrate, and the silane coupling agent are simultaneously used in such a manner that the X value specified by Formula (1) falls within the above-described preferable range, the heat resistance was able to be further improved without adversely affecting all of the flame retardancy, the appearance and the mechanical characteristics of the flame-retardant crosslinked resin molded body.

Further, according to Examples 1 to 22, the flame-retardant crosslinkable resin composition and the flame-retardant silane master batch each having a capability of producing the flame-retardant crosslinked resin molded body having the combination of the excellent flame retardancy, heat resistance, appearance, and mechanical characteristics could be prepared.

In contrast, in Comparative Examples 1 and 5 in which the blending amount of the metal hydrate is small, and the X value specified by Formula (I) is excessively small, at least the appearance, the heat resistance and the flame retardancy were deemed to be not passable. On the other hand, in Comparative Examples 2 and 3 in which the X value specified by Formula (I) is excessively large, the heat resistance was deemed to be not passable. In Comparative Example 4 in which the blending amount of the silane coupling agent is excessively small, the appearance and the heat resistance were deemed to be not passable. In Comparative Example 6 in which the blending amount of the metal hydrate is small, and the X value specified by Formula (I) is excessively large, the heat resistance and the flame retardancy were deemed to be not passable. In Comparative Example 7 in which the blending amount of the metal hydrate is small, the flame retardancy was deemed to be not passable.

Having described our invention as related to the present embodiments, it is our intention that the invention not be limited by any of the details of the description, unless otherwise specified, but rather be construed broadly within its spirit and scope as set out in the accompanying claims.

1. A method of producing a flame-retardant crosslinked resin molded body, comprising the following steps (1), (2) and (3):
a step (1): obtaining a mixture by mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst;
step (2): obtaining a molded body by molding the mixture obtained in the step (1); and
step (3): obtaining a flame-retardant crosslinked resin molded body by bringing the molded body obtained in the step (2) into contact with water,
wherein the step (1) has the following steps (a) to (d):
step (a): mixing the organic peroxide, the inorganic filler in which an X value specified by Formula (I) satisfies 7 to 850, and the silane coupling agent;
X=ΣA/B Formula (I)
wherein, ΣA denotes a total amount of a product of a BET specific surface area (m²/g) of the inorganic filler and a blending amount of the inorganic filler, and B denotes a blending amount of the silane coupling agent;
step (b): melt-mixing the mixture obtained in the step (a) with a whole or part of the polyolefin-based resin at a temperature equal to or higher than a decomposition temperature of the organic peroxide;
step (c): mixing the silanol condensation catalyst with, as a carrier resin, a resin different from the polyolefin-based resin or a remaining portion of the polyolefin-based resin; and
step (d): mixing a melted mixture obtained in the step (b) with a mixture obtained in the step (c).

2. The method of producing a flame-retardant crosslinked resin molded body according to claim 1, wherein the silane coupling agent is vinyltrimethoxysilane or vinyltriethoxysilane.

3. The method of producing a flame-retardant crosslinked resin molded body according to claim 1, wherein the inorganic filler contains at least one kind selected from the group consisting of silica, calcium carbonate, magnesium carbonate, clay, kaoline, talc, zinc borate, zinc hydroxystannate, and antimony trioxide.

4. A method of producing a flame-retardant crosslinkable resin composition, comprising the step of:
mixing 0.02 to 0.6 part by mass of organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst;
wherein the step has the following steps (a) to (d):
step (a): mixing the organic peroxide, the inorganic filler in which an X value specified by Formula (I) satisfies 7 to 850, and the silane coupling agent;
X=ΣA/B Formula (I)
wherein, ΣA denotes a total amount of a product of a BET specific surface area (m²/g) of the inorganic filler and a blending amount of the inorganic filler, and B denotes a blending amount of the silane coupling agent;
step (b): melt-mixing the mixture obtained in the step (a) with a whole or part of the polyolefin-based resin at a temperature equal to or higher than a decomposition temperature of the organic peroxide;
step (c): mixing the silanol condensation catalyst with, as a carrier resin, a resin different from the polyolefin-based resin or a remaining portion of the polyolefin-based resin; and
step (d): mixing a melted mixture obtained in the step (b) with a mixture obtained in the step (c).

5. A flame-retardant crosslinkable resin produced by the method of producing a flame-retardant crosslinkable resin composition according to claim 4.

6. A flame-retardant crosslinked resin molded body produced by the method of producing a flame-retardant crosslinked resin molded body according to claim 1.

7. A molded article, containing the flame-retardant crosslinked resin molded body according to claim 6.

8. A flame-retardant silane master batch used for producing a flame-retardant crosslinkable resin composition prepared by mixing 0.02 to 0.6 parts by mass of an organic peroxide, an inorganic filler containing at least 20 to 350 parts by mass of metal hydrate, and 2 to 15.0 parts by mass of a silane coupling agent, based on 100 parts by mass of a polyolefin-based resin, and a silanol condensation catalyst,
wherein the flame-retardant silane master batch is prepared through the following steps (a) and (b):
step (a): mixing the organic peroxide, the inorganic filler in which an X value specified by Formula (I) satisfies 7 to 850, and the silane coupling agent;
X=ΣA/B Formula (I)
wherein, ΣA denotes a total amount of a product of a BET specific surface area (m²/g) of the inorganic filler and a blending amount of the inorganic filler, and B denotes a blending amount of the silane coupling agent;
step (b): melt-mixing the mixture obtained in the step (a) with a whole or part of the polyolefin-based resin at a temperature equal to or higher than a decomposition temperature of the organic peroxide.
